(19) United States
(12) Patent Application Publication
(10) Pub. No.: US 2008/0165554 A1
(43) Pub. Date: Jul. 10, 2008

(54) Control method of power converter

(75) Inventor: Chih-Jen Teng, Taoyuan Hsien (TW)

Correspondence Address: Joe McKinney Muncy, PO Box 1364, Fairfax, VA, 22038-1364, US

(73) Assignee: SPI ELECTRONIC CO., LTD.

(21) Appl. No.: 11/651,003

(22) Filed: Jan. 9, 2007

(51) Int. Cl. H02M 7/5383

(52) U.S. Cl. 363/74

(57) ABSTRACT

A control method of a power converter for modulating a power signal outputted from a power converter to a load according to a feedback signal of the load includes the steps of: receiving a reference signal to determine outputting a modulation signal; receiving the modulation signal to determine outputting an electric conduction signal based on the working condition of a transformer unit in the power converter; receiving the electric conduction signal to determine outputting an oscillation signal of the transformer unit; modulating the duty cycle and frequency of the modulation signal simultaneously according to a feedback signal, if said feedback signal is inputted; receiving the modulation signal to change a power operating time interval for outputting the electric conduction signal; and receiving the electric conduction signal after the power operating time interval is changed to determine outputting the oscillation signal of the transformer unit.

### FIELD OF THE INVENTION

The present invention relates to a control method, and more particularly to a control method for a power converter.

### BACKGROUND OF THE INVENTION

Backlight module is a key component for providing a light source or display devices. In addition to providing a light source for illumination, a backlight module also provides a basic dimming function for an application of changing the actual illumination effect of the backlight module according to feedback signal of the backlight module.

The power source of existing backlight modules available in the market usually adopts a high-voltage inverter, and the inverter modulates an oscillation signal for driving the load according to a feedback signal of the load, wherein the methods of modulating an inverter can be roughly divided into two types: a frequency modulation type and a modulated duty cycle type, and the modulated duty cycle type inverter changes the width of oscillation signal according to the feedback signal to comply with a power change of the load; and the frequency modulation type inverter belongs to a high-level and complicated processing method operated with a fixed width of duty cycle (wherein the duty cycle is generally set to 50%), and an IC chip is used to define the conditions of an equivalent frequency table for changing an oscillation signal according to a feedback signal, so as to achieve the same effect of the modulated duty cycle type inverter.

For practical operating conditions of the inverter, it is necessary to consider the working frequency of other circuits and components when the inverter drives a load, so as to avoid any interference among the frequencies of other circuits and components and an inverter or a load. Therefore, it is necessary to restrict a change of frequencies of the driving power of an inverter and prevent an interference caused by a large change of frequencies, and thus related power supply manufacturers spare no effort to overcome such issue.

### SUMMARY OF THE INVENTION

The primary objective of the present invention is to use a modulation circuit to modulate the duty cycle and frequency of an oscillation signal simultaneously, so that a large change of the frequency of a power signal outputted by the power converter will not affect the normal operation of other electronic components.

To achieve the foregoing objective, the present invention provides a control method of a power converter which is applicable for modulating a power signal sent from a power converter to a load according to a feedback signal of the load. The control method comprises the steps of:

receiving a reference signal to determine whether or not to output a modulation signal;

receiving the modulation signal to determine whether or not to output an electric conduction signal corresponding to the working condition of a transformer unit in the power converter;

receiving the electric conduction signal to determine whether or not to output an oscillation signal of the transformer unit in the power converter;

changing the duty cycle and frequency of the modulation signal simultaneously according to a feedback signal, if the feedback signal is inputted;

receiving the modulation signal with modulated duty cycle and frequency to change the power operating time interval for outputting the electric conduction signal; and

receiving the electric conduction signal after the power operating time interval is changed to determine whether or not to output an oscillation signal of the transformer unit in the power converter.

### BRIEF DESCRIPTION OF THE DRAWINGS

FIG. 1 shows a schematic circuit diagram of a preferred embodiment of the present invention;

FIG. 2 shows a curve of a load resonance of a preferred embodiment of the present invention;

FIG. 3 shows a waveform diagram of signals before feedbacks of a preferred embodiment of the present invention;

FIG. 4 shows a waveform diagram of signals after feedbacks of a preferred embodiment of the present invention;

FIG. 5 shows a schematic circuit diagram of another preferred embodiment of the present invention; and

FIG. 6 shows a waveform diagram of signals after feedbacks of another preferred embodiment of the present invention.

### DETAILED DESCRIPTION OF THE PREFERRED EMBODIMENTS

The present invention will now be described in more detail hereinafter with reference to the accompanying drawings that show various embodiments of the invention.

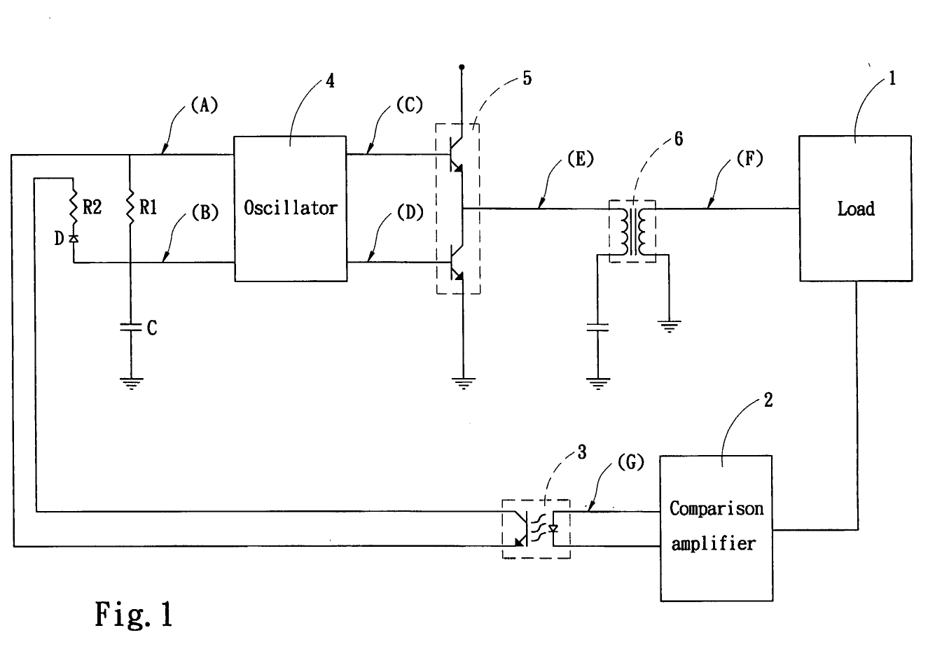

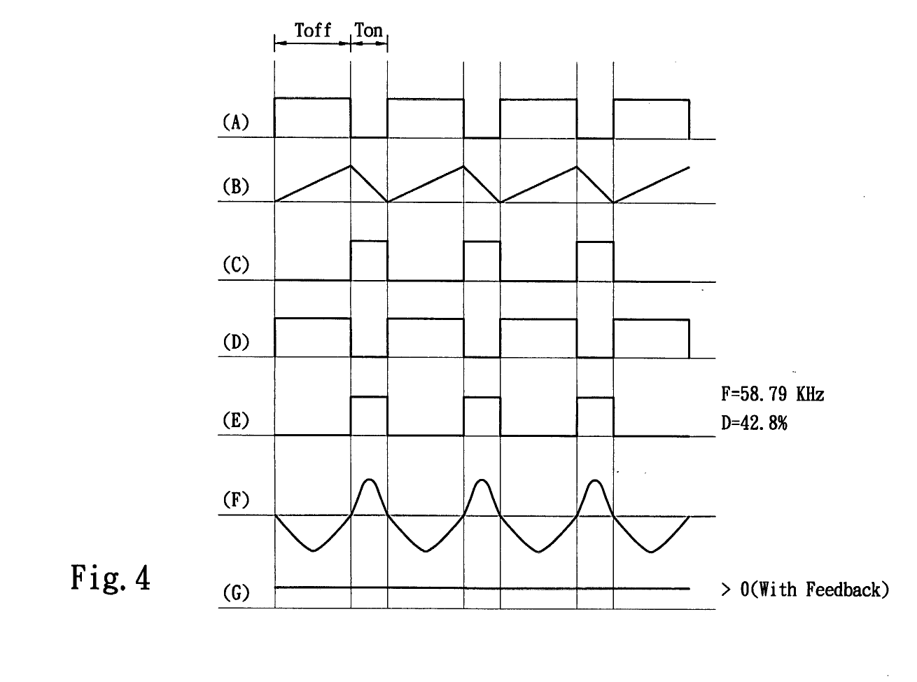

Referring to FIGS. 1 to 4 for a schematic circuit diagram, a curve of a load resonance, a waveform diagram of signals before and after feedbacks, and an exploded view of a preferred embodiment of the present invention respectively, the present invention relates to a control method of a power converter, which is applicable for modulating a power signal outputted from a power converter to a load 1 according to a feedback signal of the load 1. In this embodiment of the invention, the power converter of the circuit is an inverter, and a control method and an implemented circuit comprise:

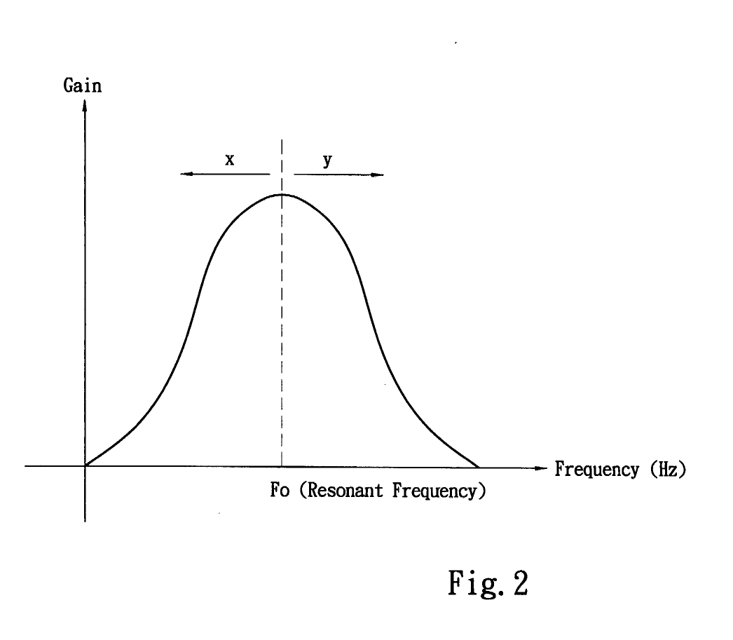

(A) A signal generator circuit receives a reference signal A generated by an oscillator 4 to determine whether or not to output a modulation signal B, and the signal generator circuit of this embodiment is comprised of a resistor R1 and a capacitor C, wherein the formula for the charge/discharge of the resistor R1 and capacitor C is given by V(t)−V(0)=[V(∞)−V(0)]*(1−e^{t/RC}), and the oscillator 4 copes with the characteristics of the signals produced by the resistor R1 and the capacitor C. If the voltage of the modulation signal B is greater than ⅔ of VHIGH, then the reference signal A will drop from V_{HIGH} to 0 volt. If the voltage of the modulation signal B is smaller than ⅓ of V_{HIGH}, then the reference signal A will rise from 0 volt to V_{HIGH}, wherein the oscillator 4 can be a pulse width modulator (PWM) that integrates the resistor R1 and the capacitor C, and the resonant frequency F0 of the load 1 is equal to 51.2 KHz in this preferred embodiment. For simplicity, the equivalent impedance oscillation frequencies generated by the resistor R1, resistor R2, diode D and capacitor C are considered to be greater than 51.2 KHz, so that the working frequency of the load 1 at a working area which is situated at Area Y of the load resonance curve as shown in FIG. 2 is inversely proportional to the gain of the driving power at the load 1, and the duty cycle of a signal D is equal to 50% before the feedback signal G is inputted.

(B) A control unit D receives the modulation signal B to determine whether or not to output the electric conduction signals C, D according to the working condition of the transformer unit 6 corresponding to the power converter, wherein the electric conduction signals C, D have the attribute values of power operating time interval, and the power operating time interval includes a power connecting time interval and a power disconnecting time interval. In this embodiment, the control unit is an oscillator 4, and the circuit of a preferred embodiment of the present invention is a magnetic transformer. In correspondence with the 50% modulation signal B as shown in FIG. 1, the electric conduction signals C, D are also 50% ON and 50% OFF.

(C) A driver 5 receives the electric conduction signals C, D to determine whether or not to output an oscillation signal F of the transformer unit 6 in the power converter. In this preferred embodiment, the driver 5 is a power transistor of a dual toggle switch, and the leakage inductance of the transformer unit 6 and the resonance of the load 1 are used to convert the power signal E of a square wave into an oscillation signal F of a sine wave form for driving the load 1.

(D) If the load 1 sends a feedback signal G from a comparison amplifier 2, a modulation circuit will change the waveform, duty cycle and frequency of the modulation signal B simultaneously according to the feedback signal G at a standard level of the reference signal A. In this preferred embodiment, the modulation circuit is comprised of an optical coupling unit 3 for obtaining a feedback signal G and a resistor R2 and a diode D connected in series with the optical coupling unit 3. If the feedback signal G is inputted, the characteristics of the capacitor C of the charge/discharge circuit will keep the impedance of the charge circuit unchanged, and the impedance of the discharge circuit will be changed from the original R1 to 1/[(1/R1+1/(R2+RFB)], wherein RFB is the equivalent impedance of the optical coupling unit 3. Since the impedance of the discharge circuit is increased, therefore the discharge time is expedited, and the first time interval Ton of the modulation signal B is reduced, and the second time interval Toff remains unchanged, so that the waveform, duty cycle and frequency of the modulation signal B are modulated simultaneously.

(E) After the simultaneously modulated waveform, duty cycle and frequency are received, the modulation signal B changes the power operating time interval of outputting the electric conduction signals C, D, wherein the power connecting time interval and the power disconnecting time interval determine the first time interval Ton and the second time interval Toff of the modulation signal B respectively.

(F) After the changed power operating time interval is received, the electric conduction signals C, D determine whether or not to output an oscillation signal F of the transformer unit 6 in the power converter, wherein the positive half-cycle time interval and the negative half-cycle time interval of an oscillation signal F of the transformer unit 6 determine the power connecting time interval and the power disconnecting time interval of the electric conduction signal C, D, and the power connecting time interval and the power disconnecting time interval are determined by the first time interval Ton and the second time interval Toff of the modulation signal B according to the formulas: Duty Cycle=Ton/(Ton+Toff) and Frequency=1/(Ton+Toff), and then the modulated power operating time interval also can module the duty cycle of the oscillation signal F to 42.8% and the frequency to 58.79 KHz simultaneously in order to achieve the effect of reducing the gain of the driving power of the load 1. The duty cycle and frequency of the oscillation signal F can be modulated simultaneously, and thus any large change of frequency of the working signal of the load 1 will not affect the normal operation of other electronic components.

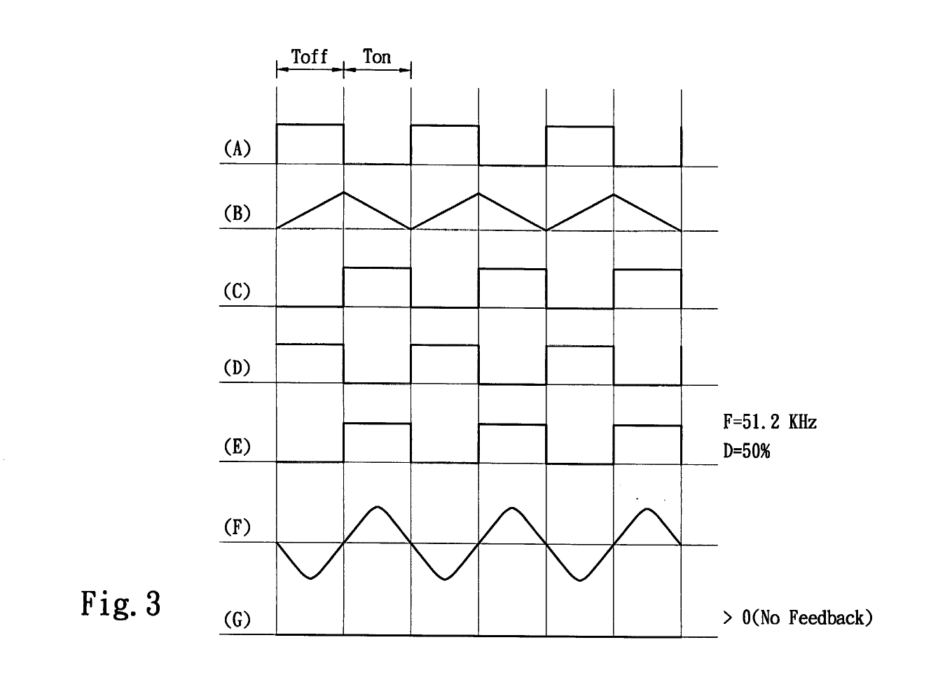

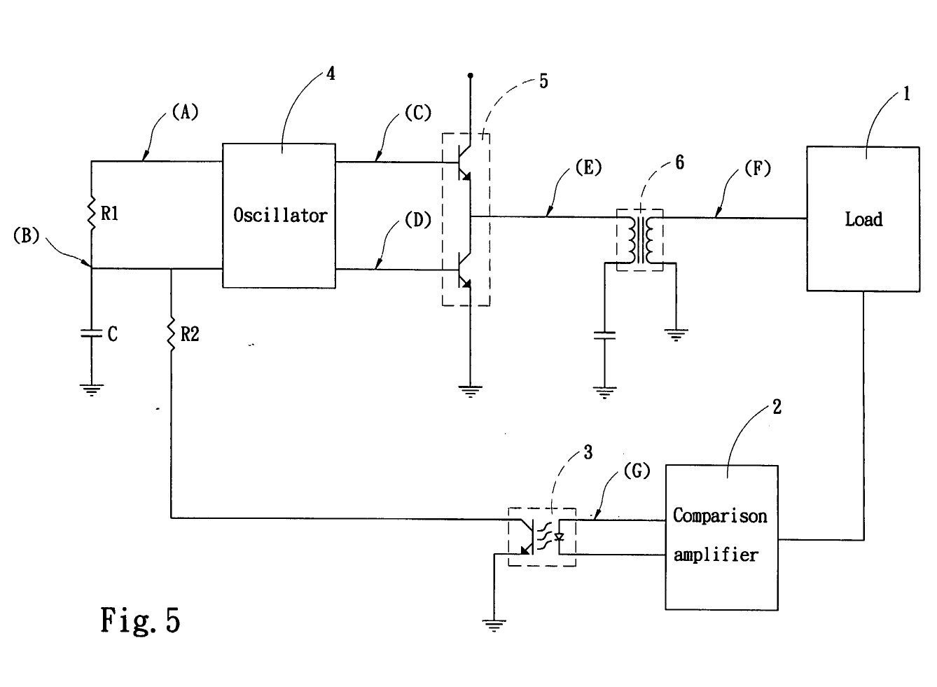

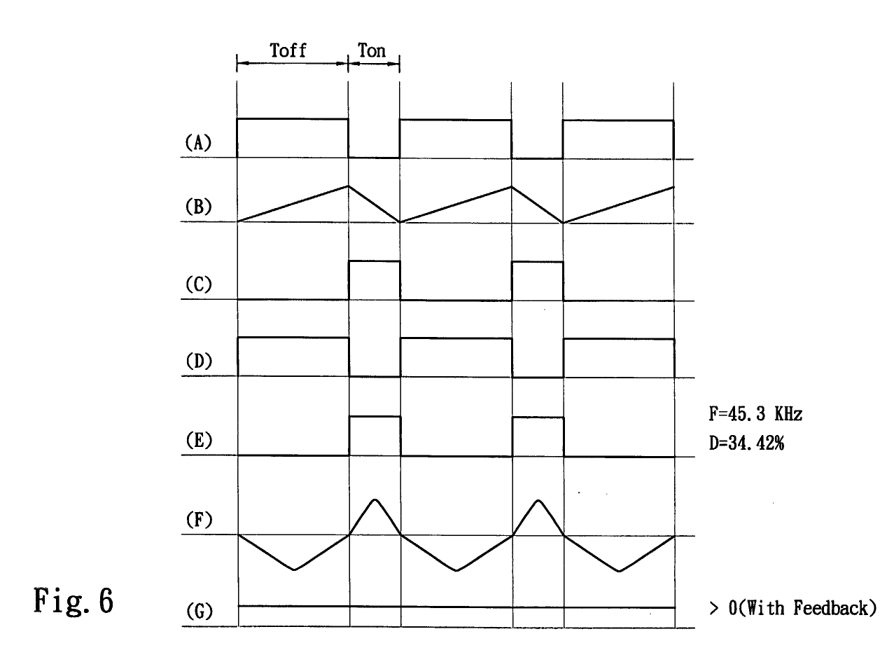

Referring to FIGS. 5 and 6 for a schematic circuit diagram and a waveform diagram of signals after feedbacks in accordance with another preferred embodiment of the present invention respectively as well as FIGS. 2 and 3, the difference between this embodiment with the aforementioned embodiment resides on that the modulation circuit is comprised of an optical coupling unit 3 for obtaining a feedback signal G and a resistor R2 connected in series with the optical coupling unit 3, and the feedback point of the optical coupling unit 3 is electrically connected to a capacitor C through the resistor R2, and the resonant frequency F0 of a load 1 is remained at 51.2 KHz, and the equivalent impedance oscillation frequencies produced by the resistor R1, resistor R2 and capacitor C are considered to be less than 51.2 KHz, so that their operating area is situated at the Area X of a load resonance curve as shown in FIG. 2, indicating that the working frequency of the load 1 is directly proportional to the gain of the driving power of the load 1. If a feedback signal G is inputted, the duty cycle of the oscillation signal F is modulated to 34.42% and the frequency to 45.3 KHz, so as to reduce the gain of the driving power of the load 1 similarly.

In the circuit of a load driven by a power converter with working area situated at Area X of a load resonance curve as illustrated in FIG. 2, the working frequency of the load 1 is directly proportional to the load 1 of a gain of the driving power. When a feedback signal G is inputted, the characteristic of the charge/discharge circuit causes an increase of charge time and a decrease of discharge time, so that the first time interval Ton of the modulation signal B is decreased, and the second time interval Toff is increased to modulate both the power operating time interval and the duty cycle and frequency of the oscillation signal F simultaneously, so as to achieve the effects of reducing the gain of the driving power of the load 1. With the simultaneous modulation of the duty cycle and frequency of the oscillation signal F, a large change of frequency of the working signal of the load 1 will not affect the normal operation of other electronic components.

It is noteworthy to point out that the aforementioned two embodiments adopt an inverter for the power converter, and a DC/DC power converter or a voltage regulator can be used as a substitute.

In summation of the description above, the working frequency of a load 1 (regardless of its working area resided at Area X or Area Y of a load resonance curve as shown in FIG. 2) and the gain of a driving power of the load 1 are in direct proportion or inverse proportion for a circuit of a load driven by a power converter, such that when the feedback signal G is inputted, the modulation method and the modulation circuit of the present invention can prevent too-large duty cycle and frequency of a working signal (which is an oscillation signal F of a transformer unit 6) of the load 1 and a too-large frequency of the working signal of the load 1 from affecting the normal operation of other electronic components.

In summation of the description above, the present invention herein enhances over the prior art and further complies with the patent application requirements, and thus is duly applied for the patent application.

While the invention has been described by means of specific embodiments, numerous modifications and variations could be made thereto by those skilled in the art without departing from the scope and spirit of the invention set forth in the claims.

What is claimed is:

1. A control method of a power converter, applicable for modulating a power signal outputted from said power converter to a load according to a feedback signal of said load, comprising the steps of:
(A) receiving a reference signal to determine whether or not to output a modulation signal;
(B) receiving said modulation signal to determine whether or not to output an electric conduction signal based on the working condition of a transformer unit in said power converter;
(C) receiving said electric conduction signal to determine whether or not to output an oscillation signal of said transformer unit in said power converter;
(D) modulating the duty cycle and frequency of said modulation signal simultaneously according to a feedback signal, if said feedback signal is inputted;
(E) receiving said modulation signal after the duty cycle and frequency are modulated simultaneously to change a power operating time interval for outputting said electric conduction signal; and
(F) receiving said electric conduction signal after said power operating time interval is changed to determine whether or not to output said oscillation signal of said transformer unit in said power converter.

2. The control method of the power converter of claim 1, wherein said power converter made according to said control method comprises a transformer unit and a control circuit for generating an oscillation signal for said transformer unit, and said transformer unit receives an input voltage and uses said oscillation signal to convert power for driving the operation of a rear-end load, and said control circuit comprises:
a signal generator circuit, for receiving a reference signal to determine whether or not to output a modulation signal;
a control unit, for receiving a modulation signal to determine whether or not to output an electric conduction signal based on the working condition of a transformer unit in said power converter;
a driver, for receiving an electric conduction signal to determine whether or not to output an oscillation signal of said transformer unit in said power converter; and
a modulation circuit, for changing the duty cycle and frequency of said modulation signal simultaneously according to said feedback signal.

3. The control method of the power converter of claim 2, wherein said signal generator circuit is comprised of a resistor for receiving a reference signal and a capacitor connected in series with said resistor for outputting a modulation signal in parallel.

4. The control method of the power converter of claim 2, wherein said control unit is an oscillator.

5. The control method of the power converter of claim 2, wherein said signal generator circuit is integrated with said control unit to form a pulse width modulator.

6. The control method of the power converter of claim 2, wherein said driver is a power transistor of a dual toggle switch.

7. The control method of the power converter of claim 3, wherein said Step (D) changes the duty cycle and frequency of said modulation signal simultaneously according to the charge/discharge time of said capacitor of said signal generator circuit, if said feedback signal is inputted.

8. The control method of the power converter of claim 2, wherein said modulation circuit is comprised of an optical coupling unit for obtaining a feedback signal and a resistor connected in series with a resistor and a diode of said optical coupling unit.

9. The control method of the power converter of claim 2, wherein said modulation circuit is comprised of an optical coupling unit for obtaining a feedback signal and a resistor connected in series with said optical coupling unit.

10. The control method of the power converter of claim 1, wherein said Step (D) changes the duty cycle and frequency of said modulation signal and also modulates the waveform of said modulation signal, if said feedback signal is inputted.

11. The control method of the power converter of claim 1, wherein said power converter is one selected from the collection of an inverter, a voltage regulator and a DC/DC power converter.
